(19) United States
(12) Patent Application Publication
(10) Pub. No.: US 2021/0015590 A1
(43) Pub. Date: Jan. 21, 2021

(54) DENTAL IMPLANT MULTIFUNCTIONAL ABUTMENT

(71) Applicant: CORTEX DENTAL IMPLANTS INDUSTRIES LTD., Shlomi (IL)

(72) Inventor: ALIAKSEI SHAROU, NAHARIYA (IL)

(21) Appl. No.: 16/720,648

(22) Filed: Dec. 19, 2019

(30) Foreign Application Priority Data
Jul. 18, 2019 (IL) 268162

(51) Int. Cl. A61C 8/00; A61C 9/00

(52) U.S. Cl. CPC A61C 8/0078; A61C 9/0053; A61C 8/0075; A61C 8/0062

(57) ABSTRACT

A multifunctional abutment configured to releasably connect to a dental implant comprises a body and a head at an upper edge of the body. The multifunctional abutment is configured to allow execution of multiple steps during an implantation procedure of the dental implant, while using same multifunctional abutment.

### CROSS-REFERENCE TO RELATED APPLICATION

This patent application is based upon and claims the priority of co-pending Israeli Patent Application No. 268,162, filed Jul. 18, 2019, which is incorporated herein by reference.

### FIELD OF THE INVENTION

The present subject matter relates to dental implants. More particularly, the present subject matter relates to abutments used during procedures of dental implant implantation.

### BACKGROUND OF THE INVENTION

A dental implant is a surgical component that interfaces a bone of a jaw or skull to support a dental prosthetic. A dental implant can also serve as an orthodontic anchor. At first, the dental implant is placed in the bone tissue and is left to osseointegrate. Then, a prosthetic, for example, a tooth, a bridge, a denture and the like, is attached to the dental implant. More commonly, an abutment is attached to the dental implant and then the prosthetic is attached to the abutment.

The currently available procedure of dental implant implantation, namely, placement of the dental implant in an implant site in a bone is either solely mechanical, also known as conventional; or computerized; or combined, namely a combination of mechanical and computerized procedures. The current procedure for implanting a dental implant in an implant site in the bone comprises several steps. Some exemplary steps are listed hereinafter. It should be noted that this list of steps is only exemplary and does not include steps like gum healing and recovery and osseointegration: obtaining a dental implant stored in a packaging, connecting a carrier, also used as a key, to the dental implant, removing the dental implant from the packaging, delivering the dental implant to the implant site with the aid of the carrier and inserting the dental implant into the bone. When the dental implant is inserted into the bone, a key is used for screwing the dental implant into the bone. When a surgical guide is used, the procedure comprises connecting an implant mount to the dental implant, and screwing the dental implant into the bone through the surgical guide. Then the implantation procedure comprises removing the implant mount and the carrier from the dental implant. The next step of the implanting procedure is transferring the position of the dental implant to an impression copy. This step can be either mechanical, or computerized. The mechanical transferring of the position of the dental implant to an impression copy comprises connecting an analog transfer to the dental implant, transferring the dental implant position to an analog impression copy by any procedure known in the art, including for example an open-tray position and a closed-tray procedure, and removing the analog transfer from the dental implant. The computerized transferring of the dental implant position to an impression copy comprises connecting a digital transfer, for example a scan body, to the dental implant; transferring the dental implant position to a digital impression copy, for example by scanning the scan body, and removing the digital transfer from the dental implant. A next step in the procedure can be measuring the stability of the dental implant. This is done by connecting an implant stability quotient (ISQ) gauge to the dental implant, measuring ISQ parameters of the dental implant, and removing the ISQ gauge from the dental implant.

The impression copy of the implant is required for determining whether the implant is correctly inserted into the implant site. This is done by comparing the implant impression with a planned position of the insert. If the implant is correctly inserted into the implant site as planned, the impression copy is used in the next stage of preparing and connecting the prosthetic to the implant. More commonly, as mentioned above, an abutment is connected to the implant before connecting the prosthetic.

It can be appreciated that the aforementioned prior art procedure comprises connection of several types of tools, or accessories, or abutments, to the dental implant and removal of the tools, or accessories, or abutments, from the dental implant. This renders the prior art implantation procedure rather complicated and complex, and requires a high degree of expertise, exerted for example by highly trained oral surgeons and periodontists. However, basic and more complicated surgical implant services are increasingly provided not only by highly trained professionals, but also by general dentists that lack the required expertise.

### SUMMARY OF THE INVENTION

Unless otherwise defined, all technical and scientific terms used herein have the same meaning as commonly understood by one of ordinary skill in the art to which this subject matter belongs. Although methods and materials similar or equivalent to those described herein can be used in the practice or testing of the present subject matter, suitable methods and materials are described below. In case of conflict, the patent specification, including definitions, will control. In addition, the materials, methods, and examples are illustrative only and not intended to be limiting.

According to one aspect of the present subject matter, there is provided a multifunctional abutment configured to releasably connect to a dental implant, the multifunctional abutment comprising: a body; and a head at an upper edge of the body, wherein the multifunctional abutment is configured to allow execution of multiple steps during an implantation procedure of the dental implant, while using same multifunctional abutment.

According to one embodiment, the multifunctional abutment is further configured to connect to the dental implant with a connector.

According to another embodiment, the multifunctional abutment further comprises at a top side of the head a carrier connection element configured to be gripped by a carrier.

According to yet another embodiment, the body is configured to serve as an implant mount, so the dental implant could be inserted into a bone through a surgical guide.

According to still another embodiment, the multifunctional abutment further comprises a stopper at a bottom edge of the head, or in a border between the head and the body, wherein the stopper is configured to prevent further insertion of the dental implant into a bone when the stopper comes in contact with a surgical guide.

According to a further embodiment, the multifunctional abutment is further configured to serve as an analog transfer, by being configured to be embedded in a hardened impression material and released from the dental implant.

According to yet a further embodiment, the head is further configured to serve as a scan body, thereby the multifunctional abutment is further configured to serve as a digital transfer.

According to still a further embodiment, the head further comprises an orientation mark that is configured to allow determination of an orientation of the dental implant during digital impression.

According to an additional embodiment, the head further comprises a marking configured to mark a type of the dental implant in a scanned image acquired during scanning of the multifunctional abutment.

According to yet an additional embodiment, at least part of a surface of the head is configured to be scanned and seen in a scanned image that is acquired during scanning.

According to still an additional embodiment, the at least part of the surface of the head that is configured to be scanned and seen in the scanned image is chemically treated so it could be used directly as a scan body.

According to one embodiment, the at least part of the surface of the head that is configured to be scanned and seen in the scanned image is opaque to light.

According to yet another embodiment, at least part of the multifunctional abutment is magnetic.

According to still another embodiment, the multifunctional abutment is configured to be used as an implant stability quotient (ISQ) gauge.

According to a further embodiment, the multifunctional abutment is made of a biocompatible material.

According to still a further embodiment, the multifunctional abutment is configured to be milled to form a customized abutment that is configured to be used as an abutment that holds a crown attached to the dental implant.

According to another aspect of the present subject matter, there is provided a method for comparing a position and orientation of an at least one implanted dental implant in a patient's mouth with a planned position and orientation of the at least one dental implant in the patient's mouth, the method comprising: providing a first 3D-image of a patient's mouth before implantation, comprising a 3D-image showing a planned position and orientation of at least one dental implant implanted in the patient's mouth; providing a second 3D-image of a patient's mouth after implantation of at least one dental implant, each dental implant is connected to a multifunctional abutment as described herein; transforming the second 3D-image to a third 3D-image, by adding to the second 3D-image at least one 3D-image of at least one virtual multifunctional abutment and at least one 3D-image of at least one virtual dental implant, wherein the at least one virtual multifunctional abutment is similar to the at least one multifunctional abutment that is in the patient's mouth, and wherein the at least one virtual dental implant is similar to the at least one dental implant that is in the patient's mouth, and wherein the third 3D-image shows a position and orientation of the at least one multifunctional abutment and the at least one dental implant that are in the patient's mouth; overlapping the first 3D-image with the third 3d-image giving rise to a combination 3d-image; and comparing the first 3D-image with the third 3D-image in the combination 3D-image for evaluating a difference in the position and orientation of the at least one implanted dental implant relative to the planned position and orientation of the at least one dental implant.

According to one embodiment, the second image is acquired by scanning the patient's mouth.

According to another embodiment, the virtual image of the at least one multifunctional abutment is provided from a library of virtual images of various types of multifunctional abutments.

According to yet another embodiment, the virtual image of the dental implant is provided from a library of virtual images of various types of dental implants.

According to still another embodiment, the method further comprises after the comparing the first image with the second image in the combination image, a report summarizing the difference in the position and orientation of the implanted dental implant relative to the planned position and orientation of the dental implant.

According to yet another aspect of the present subject matter, there is provided a system for comparing a position and orientation of an at least one implanted dental implant in a patient's mouth with a planned position and orientation of the at least one dental implant in the patient's mouth according to embodiments described herein, the system comprising: a processor configured to perform computations required during the comparing; a memory unit connected to the processor and configured to store data; an input/output (I/O) module, connected to the processor and configured to transmit, or receive, or transmit and receive information and instructions between the processor and other components of the system; and a 3D-scanner connected to the I/O module and configured to acquire 3D-images.

According to one embodiment, the system further comprises a display connected to the I/O module and configured to display data received from the processor through the I/O module.

According to another embodiment, the I/O module is configured to be connected to the internet.

### BRIEF DESCRIPTION OF THE DRAWINGS

Embodiments are herein described, by way of example only, with reference to the accompanying drawings. With specific reference now to the drawings in detail, it is stressed that the particulars shown are by way of example and for purposes of illustrative discussion of the preferred embodiments, and are presented in the cause of providing what is believed to be the most useful and readily understood description of the principles and conceptual aspects of the embodiments. In this regard, no attempt is made to show structural details in more detail than is necessary for a fundamental understanding, the description taken with the drawings making apparent to those skilled in the art how several forms may be embodied in practice.

In the drawings:

FIG. 1 schematically illustrates, according to an exemplary embodiment, a front perspective view of a multifunctional abutment connected to a dental implant.

FIG. 2 schematically illustrates, according to an exemplary embodiment, a side view of a multifunctional abutment connected to a dental implant.

FIG. 3 schematically illustrates, according to an exemplary embodiment, a side cross-section view of a multifunctional abutment connected to a dental implant.

FIG. 4 schematically illustrates, according to an exemplary embodiment, a side view of a multifunctional abutment.

FIG. 5 schematically illustrates, according to an exemplary embodiment, a side cross-section view of a multifunctional abutment.

FIG. 6 schematically illustrates, according to an exemplary embodiment, an upper view of a multifunctional abutment.

FIG. 7 schematically illustrates, according to an exemplary embodiment, a block diagram of a method for comparing a position and orientation of an at least one implanted dental implant 20 in a patient's mouth with a planned position and orientation of the at least one dental implant 20 in the patient's mouth. This method is also known as “comparison method 40.

FIG. 8 schematically illustrates, according to an exemplary embodiment, a block diagram of a system for comparing a position and orientation of an at least one implanted dental implant 20 in a patient's mouth with a planned position and orientation of the at least one dental implant 20 in the patient's mouth.

### DESCRIPTION OF THE PREFERRED EMBODIMENTS

Before explaining at least one embodiment in detail, it is to be understood that the subject matter is not limited in its application to the details of construction and the arrangement of the components set forth in the following description or illustrated in the drawings. The subject matter is capable of other embodiments or of being practiced or carried out in various ways. Also, it is to be understood that the phraseology and terminology employed herein is for the purpose of description and should not be regarded as limiting. In discussion of the various figures described herein below, like numbers refer to like parts. The drawings are generally not to scale.

For clarity, non-essential elements were omitted from some of the drawings.

One aim of the present subject matter is to simplify the procedure of implantation of a dental implant, so the procedure could be executed not only by highly trained professionals, but also by general dentists that lack the required expertise.

Another aim of the present subject matter is to reduce the number of different tools, or accessories, or abutments that are connected to the dental implant during the implantation procedure. In order to fulfill this aim, the present subject matter provides a multifunctional abutment, also known as multifunctional accessory. For the sake of simplicity only, the term “multifunctional abutment” is used hereinafter. Thus, as described in detail herein, the multifunctional abutment is configured to be connected to dental implant and used during the entire implantation procedure. As a result, the implantation procedure would be less complicated, because it would not be necessary to connect and remove multiple tools, or accessories, or abutments, to and from the dental implant during the implantation procedure. Thus, the present subject matter reduces the chance for mistakes during the implantation procedure, since instead of using multiple tools, or accessories, or abutments, during the implantation procedure, only one multifunctional abutment that is always connected to the dental implant during the procedure is used. Furthermore, in a prior art procedure, replacement of a tool, or an accessory, or an abutment, that is connected to the dental implant when the dental implant is inserted into the bone might cause movement of the dental implant. This problem is eliminated by the present subject matter as well. Also, the time duration of the implantation procedure is reduced because there is no need to replace the tool, or the accessory, or the abutment, connected to the dental implant after each step. In addition, a kit for dental implantation of the present subject matter would comprise less components—rendering the kit less expensive, compared to the prior art kits.

The present subject matter provides a multifunctional abutment configured to allow execution of multiple steps during an implantation procedure of a dental implant, while using same multifunctional abutment.

According to one embodiment, the multifunctional abutment is configured to allow carrying of the dental implant from the packaging to the implantation site. According to another embodiment, the multifunctional abutment is configured to allow screwing of the dental implant into the bone. According to yet another embodiment, the multifunctional abutment is configured to allow screwing of the dental implant into the bone through a surgical guide. According to still another embodiment, the multifunctional abutment is configured to be used as an analog transfer. According to a further embodiment, the multifunctional abutment is configured to be used as a digital transfer. According to yet a further embodiment, the multifunctional abutment is configured to be used as an ISQ gauge.

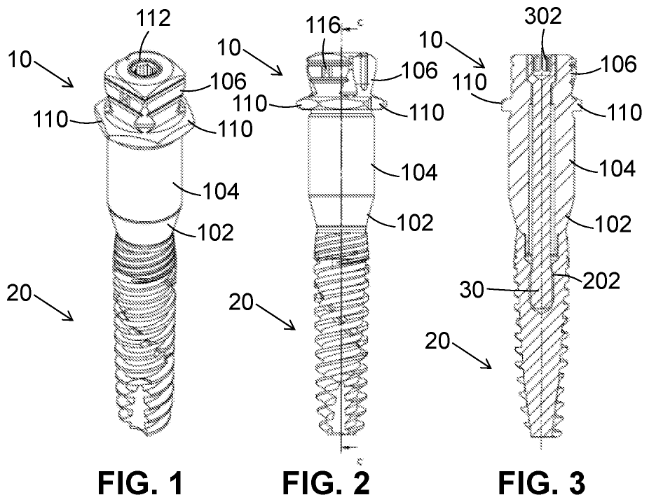

FIG. 1 schematically illustrates, according to an exemplary embodiment, a front perspective view of a multifunctional abutment connected to a dental implant.

FIG. 2 schematically illustrates, according to an exemplary embodiment, a side view of a multifunctional abutment connected to a dental implant.

FIG. 3 schematically illustrates, according to an exemplary embodiment, a side cross-section view of a multifunctional abutment connected to a dental implant.

According to one embodiment, as can be seen in FIGS. 1-3, the multifunctional abutment 10 is configured to be connected to a dental implant 20. According to another embodiment, the multifunctional abutment 10 is configured to connect to any type of dental implant 20 known in the art. An advantage of this embodiment is that there is no need to design and manufacture a dental implant 20 that specifically fits the multifunctional abutment 10. According to yet another embodiment, the multifunctional abutment 10 is configured to be releasably connected to the dental implant 20. In other words, when the multifunctional abutment 10 is connected to the dental implant 20, the multifunctional abutment 10 is configured to be released from the dental implant 20, for example after completing the implantation procedure of the dental implant 20.

According to one embodiment, the multifunctional abutment 10 is configured to be connected to the dental implant 20 with a connector 30. Any type of connector 30 known in the art, that is configured to connect, for example, releasably connect, the multifunctional abutment 10 to the dental implant 20, is under the scope of the present subject matter. An exemplary connector 30, in the form of a screw 30, is illustrated in FIG. 3. The screw 30 is configured to fit any type of dental implant known in the art. As known in the art, all dental implants 20 comprise an internal thread 202 configured to fit to a corresponding screw 30. Prior art tools, accessories and abutments that are used during the implantation procedure are connected to the dental implant 20 with a screw 30 corresponding to the internal thread 202. There are several standards of screws 30 and internal threads 202 known in the art, known for example as M2, M3, M1.6, M.16, M1.8, UN 1-72 and the like. Accordingly, the multifunctional abutment 10 can comprise one of several types of a screw 30 that fits one of the various standards of screws 30 and internal threads 202 known in the art. This embodiment allows the multifunctional abutment 10 to fit to any type of dental implant 20 known in the art. However, it should be noted that the screw 30 is only an exemplary embodiment of the connector 30, and that any type of connector 30 known in the art is under the scope of the present subject matter. Another exemplary embodiment of the connector 30 can be an elastic connector 30 that corresponds to the internal thread 202 of the dental implant 20. When the elastic connector 30 is inserted into the internal thread 202 it tends to expand and be caught by the internal thread 202.

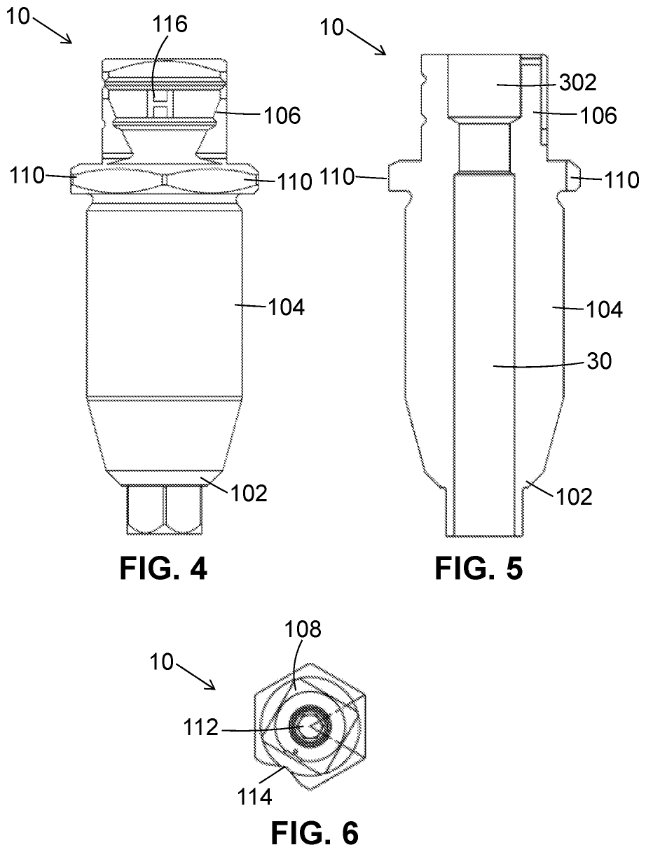

FIG. 4 schematically illustrates, according to an exemplary embodiment, a side view of a multifunctional abutment.

FIG. 5 schematically illustrates, according to an exemplary embodiment, a side cross-section view of a multifunctional abutment.

FIG. 6 schematically illustrates, according to an exemplary embodiment, an upper view of a multifunctional abutment.

According to one embodiment, the multifunctional abutment 10 comprises a body 104 and a head 106 at an upper edge of the body 104. According to another embodiment, the multifunctional abutment 10 can comprise a base 102 at a lower edge of the body 104.

According to one embodiment, the multifunctional abutment 10 is configured to connect to a carrier for delivering the dental implant 20 from the packaging to the implantation site and screwing the dental implant 20 into the bone. Thus, according to another embodiment, the multifunctional abutment 10 comprises at a top side of the head 106 a carrier connection element 108. FIG. 6 illustrates an exemplary carrier connection element 108 in the form of a standard square element that is configured to fit to a standard carrier. It should be noted that the standard square element is only exemplary, and that the carrier connection element 108 can have any shape and size known in the art that fits to any type of carrier known in the art. According to yet another embodiment, the carrier connection element 108 is configured to be gripped by a carrier. This allows delivering of the dental implant 20, to which the multifunctional abutment 10 is connected, from the packaging to the implantation site, and screwing the dental implant 20 into the bone by using the carrier that grips the carrier connection element 108.

According to one embodiment, the multifunctional abutment 10 is configured to function as an implant mount, so the dental implant 20 could be inserted into the bone through a surgical guide. According to this embodiment, the body 104 is configured to serve as an implant mount. According to another embodiment, the body 104 is configured to pass through a surgical guide during insertion of the dental implant 20 into the bone. Thus, the body 104 can have any shape known in the art that allows passage through a surgical guide, for example but not limited to, a cylindrical shape.

According to yet another embodiment, the multifunctional abutment 10 further comprises a stopper 110 at a bottom edge of the head 106, or in a border between the head 106 and the body 104. The stopper 110 is also configured to be used when insertion of the dental implant 20 into the bone is performed with a surgical guide. According to another embodiment, the stopper 110 extends beyond a surface of the cylindrical body 104. According to yet another embodiment, the stopper 110 is configured to prevent further insertion of the dental implant 20 into the bone when the stopper 110 comes in contact with the surgical guide.

According to one embodiment, the multifunctional abutment 10 is configured to serve as an analog transfer. Like a prior art analog transfer, after casting and hardening of an impression material, as known in the art, the multifunctional abutment 10 is configured to be embedded in the hardened impression material and released from the dental implant 20, like a prior art analog transfer. Thus, the multifunctional abutment 10 is configured to be unscrewed from the dental implant 20. For this purpose, according to one embodiment, the connector 30 comprises a screw driver engaging element 302 at an upper side of the connector 30, preferably at an upper side of a connector 30 in a form of a screw 30. According to this embodiment, the connector 30 reaches the head 106, and at an upper part of the head 106 there is an opening 112 that is positioned just above the screw driver engaging element 302. The opening 112 is configured to allow insertion of a screw driver so it could engage with the screw driver engaging element 302 of the connector 30. After the connector 30 is released from the dental implant 20, the multifunctional abutment 10 can be released from the dental implant 20 while embedded in the cast of the impression material. As a person skilled in the art can appreciate, this embodiment allows an open-tray procedure of analog impression.

According to a further embodiment, the multifunctional abutment 10 is also configured to be used in a closed-tray procedure of analog impression.

According to one embodiment, the multifunctional abutment 10 is configured to serve as a digital transfer. According to another embodiment, the head 106 is configured to serve as a scan body. According to yet another embodiment, the head 106 comprises an orientation mark 114 that is configured to allow determination of an orientation of the dental implant 20 during the digital impression. According to yet another embodiment, the head 106 comprises a marking 116 configured to mark the type, or platform, of the dental implant 20 in a scanned image acquired during scanning of the multifunctional abutment 10. Any type of marking 116 is under the scope of the present subject matter, preferably a laser marking. According to still another embodiment, at least part of a surface of the head 106 is configured to be scanned and seen in the scanned image that is acquired during scanning. According to this embodiment, at least part of the surface of the head 106 is chemically treated so it could be used directly as a scan body, for example by making the surface opaque to light as known in the art.

As described above, digital impression comprises scanning of the multifunctional abutment 10 that serves as a digital transfer. An advantage of this embodiment is that it allows immediate on-line determination of the actual position and orientation of the dental implant 20 in the patient's mouth and jaw, as well as comparison of determined position and orientation of the dental implant 20 with a planned position and orientation of the dental implant 20. Another advantage of this ability to immediately determining the position and orientation of the dental implant 20 by digital impression is that it makes it unnecessary to send the patient to a post-operative computer tomography (CT) that is currently used in the practice for determining the actual position and orientation of the dental implant 20. Needless to mention the advantage of online digital impression that saves the patient from an unnecessary CT irradiation.

According to one embodiment, the multifunctional abutment 10 is configured to be used as an ISQ gauge. According to another embodiment, at least part of the multifunctional abutment 10 is magnetic, so it can be used with an ISQ measurement equipment. According to a further embodiment, the multifunctional abutment 10 is made at least partially, or entirely, of a magnetic material. According to yet a further embodiment, the multifunctional abutment 10 comprises a magnet.

According to one embodiment, the multifunctional abutment 10 is made of any material known in the art that is used for manufacturing abutments and tools used during an implantation of a dental implant 20. According to a preferred embodiment, the multifunctional abutment 10 is made of a biocompatible material. Any type of biocompatible material, in any level of biocompatibility, known in the art for manufacturing abutments and tools used during an implantation of a dental implant 20 is under the scope of the present subject matter. Some exemplary material of which the multifunctional abutment 10 can be made include, but not limited to, a metal, a ceramic material, a plastic material and any combination thereof. Some exemplary metals include titanium, gold, chrome, cobalt and the like and any combination thereof. Some exemplary ceramic materials include glass, zirconia, and the like and any combination thereof. An exemplary plastic material is polyether ether ketone (PEEK) and the like. Some exemplary combinations of materials include, but not limited to, titanium-gold, cobalt-chrome, titanium-zirconia, plastic material-zirconia and the like. It should be emphasized again that the aforementioned materials of which the multifunctional abutment 10 can be made are only exemplary and should not be considered as limiting the scope of the present subject matter.

According to one embodiment, the multifunctional abutment 10 can be manufactured by using any method known in the art for manufacturing of abutments and tools used during an implantation of a dental implant 20. Some exemplary methods include, but not limited to, milling, turning, grinding, casting, coating, chemical etching, engraving, sandblasting, polishing, electropolishing, marking, heat treatment, sintering, injection molding and the like. It should be noted that a person skilled in the art would be able to manufacture the multifunctional abutment 10 by the methods known in the art.

According to one embodiment, the multifunctional abutment 10 is configured to be used as an abutment blank. According to this embodiment, after usage of the multifunctional abutment 10 during the implantation procedure, the multifunctional abutment 10 is configured to be milled to form a customized abutment that is configured to be used as an abutment that holds a crown attached to the dental implant 20—as known in the art. According to this embodiment, the multifunctional abutment 10 is made of a biocompatible material, for example titanium. According to another embodiment, the connector 30 of the multifunctional abutment 10 can be used to connect the customized abutment to the dental implant 20. According to yet another embodiment, the multifunctional abutment 10 is configured to be fixed to a milling equipment, used as known in the art, for milling and manufacturing the customized abutment. The fixation of the multifunctional abutment 10 to the milling equipment can be achieved, for example, with the connector 30.

An advantage of this embodiment—of the multifunctional abutment 10 configured to be used as an abutment blank, is that it further reduces the price of the dental restoration, since there is no need to invest in abutment blanks. Once the implantation procedure is completed, the same multifunctional abutment 10 that was used during the implantation procedure, is also used as an abutment blank.

As described above, the multifunctional abutment 10 is configured to be used during the entire procedure of implanting a dental implant 20 in a bone. As known in the art, there are several types of implantation procedures, for example one-stage procedure, two-stage and the like. During a one-stage implantation procedure, the multifunctional abutment 10 can be connected to the dental implant 20 during the entire procedure and be used during the various stages of the procedure, as described above. Thus, immediately after the implant insertion and the removal of the multifunctional abutment 10, a healing abutment is connected to the dental implant 20. On the other hand, during the two-stage implantation procedure, the multifunctional abutment 10 can be removed from the dental implant 20, in order to allow, for example, connection of a cover screw. Once the rehabilitation period is over, the cover screw is replaced by a healing abutment. Then, after the healing period is completed, the multifunctional abutment 10 can be used again, for example as an analog transfer or a digital transfer.

According to one embodiment, the multifunctional abutment 10 is configured to be used in a method for comparing a position and orientation of an at least one implanted dental implant 20 in a patient's mouth with a planned position and orientation of the at least one dental implant 20 in the patient's mouth. For the sake of simplicity only, this method can be occasionally termed hereinafter “method for comparing”. The method for comparing can be used for an at least one implanted dental implant 20, when each of the dental implants 20 is connected to a multifunctional abutment 10 as described herein. According to another embodiment, during the usage of the multifunctional abutment 10 in the method for comparing, the multifunctional abutment 10 is scanned as described herein. This is achieved due to the head 106 of the multifunctional abutment 10 that is configured to serve as a scan body, according to embodiments described herein.

The present subject matter provides a method for comparing a position and orientation of an at least one implanted dental implant 20 in a patient's mouth with a planned position and orientation of the at least one dental implant 20 in the patient's mouth. For the sake of simplicity only, this method is occasionally termed hereinafter “Comparison method”. It should be noted that the comparison method is suitable for dental implants 20 connected to multifunctional abutments 10 according to embodiments of the present subject matter.

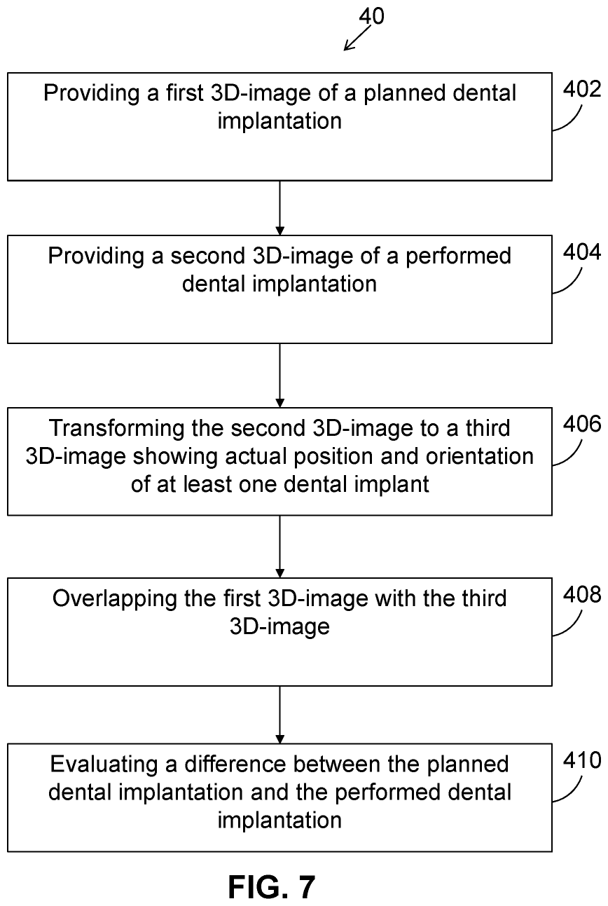

FIG. 7 schematically illustrates, according to an exemplary embodiment, a block diagram of a method for comparing a position and orientation of an at least one implanted dental implant 20 in a patient's mouth with a planned position and orientation of the at least one dental implant 20 in the patient's mouth. This method is also known as “comparison method 40.

According to one embodiment, the comparison method uses three-dimensional images, designated hereinafter “3D-image” or “3D-images”.

According to one embodiment, the comparison method 40 comprises:
providing a first 3D-image of a patient's mouth before implantation, comprising a 3D-image showing a planned position and orientation of at least one dental implant 20 implanted in the patient's mouth. In FIG. 7 this step is shown as step 402 of providing a first 3D-image of a planned dental implantation. As can be understood, the first 3D-image is a combination of a 3D-image of the patient's mouth before implantation with a 3D-image showing a planned position and orientation of at least one dental implant 20 that is to be implanted in the patient's mouth.
providing a second 3D-image of a patient's mouth after implantation of at least one dental implant 20, each dental implant 20 is connected to a multifunctional abutment 10, according to embodiments of the present subject matter. In FIG. 7 this step is shown as step 404 of providing a second 3D-image of a performed dental implantation. According to one embodiment, the second 3D-image shows at least one scanned multifunctional abutment 10, each connected to one of at least one dental implant 20 implanted in the patient's mouth. According to another embodiment, the second 3D-image is acquired by scanning the patient's mouth. Thus, the second 3D-image shows the mouth of the patient after implantation, as well as the position and orientation of an exposed part of the at least one multifunctional abutment 10 that is configured to be scanned, as described above. It should be understood that since the second 3D-image is an image that shows surfaces of the patient's mouth, teeth and multifunctional abutments 10, for example the second image is a scanned image, only an exposed part of the at least one multifunctional abutment 10, above the patient's gums, is seen in the second 3D-image.
Transforming the second 3D-image to a third 3D-image, by adding to the second 3D-image at least one 3D-image of at least one virtual multifunctional abutment 10 and at least one 3D-image of at least one virtual dental implant 20, wherein the at least one virtual multifunctional abutment 10 is similar to the at least one multifunctional abutment 10 that is in the patient's mouth, and wherein the at least one virtual dental implant 20 is similar to the at least one dental implant 20 that is in the patient's mouth, and wherein the third 3D-image shows a position and orientation of the at least one multifunctional abutment 10 and the at least one dental implant 20 that are in the patient's mouth. In FIG. 7 this step is shown as step 406 of transforming the second 3D-image to a third 3D-image showing actual position and orientation of at least one dental implant 20. According to one embodiment, the 3D-image of the at least one virtual multifunctional abutment 10 is provided from a library of images of various types of virtual multifunctional abutments 10. According to another embodiment, the 3D-image of the at least one virtual dental implant 20 is provided from a library of images of various types of virtual dental implants 20. According to yet another embodiment, the 3D-image of the virtual multifunctional abutment 10 is placed in the position and orientation of the multifunctional abutment 10 that is in the patient's mouth by overlapping an exposed part of the multifunctional abutment 10 in the second 3D-image with a corresponding part in the virtual multifunctional abutment. According to still another embodiment, the 3D-image of the virtual dental implant 20 is placed in the position and orientation of the dental implant 10 that is in the patient's mouth, by virtually connecting the virtual dental implant 20 with the virtual multifunctional abutment 10.
overlapping the first 3D-image with the third 3D-image giving rise to a combination 3D-image. In FIG. 7 this step is shown as step 408 of overlapping the first 3D-image with the third 3D-image.
comparing the first 3D-image with the third 3D-image in the combination 3D-image for evaluating a difference in the position and orientation of the at least one implanted dental implant 20 relative to the planned position and orientation of the at least one dental implant 20. In FIG. 7 this step is shown as step 410 of evaluating a difference between the planned dental implantation and the performed dental implantation.

It should be noted that the order of steps 402, 404, 406, and 408 of the comparison method 40, described above and in FIG. 7, can be different and not necessarily as described, as long as these steps are performed before step 410.

According to one embodiment, the comparison method further comprises after the comparing the first 3D-image with the third 3D-image in the combination 3D-image, a report summarizing the difference in the position and orientation of the implanted dental implant 20 relative to the planned position and orientation of the dental implant 20.

According to one embodiment, the difference in the position and orientation of the implanted dental implant 20 relative to the planned position and orientation of the dental implant 20 is evaluated as known in the art, for example, by calculating at least one parameter of difference between the position and orientation of the implanted dental implant 20 relative to the planned position and orientation of the dental implant 20. Some exemplary parameters include, but not limited to, linear deviation at implant platform (Lp), linear deviation at implant apex (La), angular deviation (A), vertical deviation at implant platform (Vp), vertical deviation at implant apex (Va) and the like.

As a result of this comparison it is possible to correct the position and orientation of the implanted dental implant 20 so it would fit as much as possible to the planned position and orientation of the dental implant 20.

An advantage of the multifunctional abutment 10 of the present subject matter is, inter alia, that it allows analysis of the position and orientation of the at least one implanted dental implant 20 versus the planned position and orientation of the at least one dental implant 20, immediately after the implantation procedure, while the patient is still in the clinic, so correction of the position and orientation of the implanted dental implant 20, if necessary, is still possible. Not to mention other advantages of immediate correction of the dental implant's 20 position and orientation, like prevention of damage to the patient's jaw bones and gums and prevention of trouble and inconvenience caused to the patient that otherwise has to attend the clinic for another time in order to correct the implantation. In this regard it should be mentioned that currently available scan bodies cannot allow practice of the comparison method, for example instead of the multifunctional abutment 10. The reason for this is that currently a tool that is connected to dental implant 20 during the implantation has to be removed in order to connect the scan body. This procedure can cause movement of the dental implant 20 from the place of implantation, not to mention a potential damage that can be caused to the jaw bone and gum due to the movement of the dental implant 20. On the other hand, the multifunctional abutment 10 is connected to the dental implant 20 during the entire implantation procedure. Thus, immediately after implantation, the mouth of the patient and the multifunctional abutment are scanned, while nothing is removed from the dental implant 20 and there is no danger of movement of the dental implant 20 and a potential damage to the jaw bone and gum.

In addition to the aforementioned advantages, the usage of the multifunctional abutment 10 of the present subject matter in the comparison method is superior over the currently used abutments and methods. Currently, screening of the mouth and the abutment attached to implanted dental implant 20 provides images and information only of exposed parts, for example the abutment, neighboring teeth, gums and the like. In order to evaluate the position and orientation of the implanted dental implant 20, the patient has to undergo a CT imaging procedure, thus exposing himself to a deleterious X-ray irradiation. The CT screening is needed for getting an image of the implanted dental implant 20 that resides inside the gum and jaw bone. If it is found that a correction of the implantation has to be performed, the patient is asked to visit the clinic again in a future time. On the other, the comparison method of the present subject matter, using the multifunctional abutment 10 of the present subject matter, involves only screening of the patient's mouth by standard devices and methods. Screening is performed by using visible light that is harmless to the patient. In addition, it can be performed immediately after the implantation, while the patient is still at the clinic. Then, the comparison method is performed. The comparison method can be performed while the patient is still at the clinic. Then, as mentioned above, according to the results of the comparison method, the implantation can be corrected, if necessary, again while the patient is still at the clinic, immediately after implantation with no delay. In other words, the multifunctional abutment 10 and the comparison method provide information about the position and orientation of dental implant 20 that resides inside the patient's gum and jaw bone in a manner that involves screening of the patient's mouth with visual light.

Another advantage of using the multifunctional abutment 10 and performing the comparison method over usage of a currently available scan body and CT imaging is the resolution of the images obtained and accuracy of the analysis of the position and orientation of the implanted dental implant 20. CT images have a resolution of substantially 1 mm. That means that it is impossible to detect a bias of less than 1 mm in the position and orientation of the implanted dental implant 20 in comparison with the planned position and orientation of the dental implant 20. The comparison method, using the multifunctional abutment 10, overcomes this issue. Scanning images are more accurate than CT images. Furthermore, the image of the dental implant in its position and orientation in the patient's mouth is based on a virtual image of the dental implant 20, that is more accurate and having a higher resolution than a CT image, for example having a resolution in the range of micrometers. Therefore, the analysis with the comparison method is more accurate than prior art methods, thus giving rise to a more accurate plantation of a dental implant 20.

The present subject matter provides a system for comparing a position and orientation of an at least one implanted dental implant 20 in a patient's mouth with a planned position and orientation of the at least one dental implant 20 in the patient's mouth. For the sake of simplicity only, this system is occasionally termed hereinafter “Comparison system”.

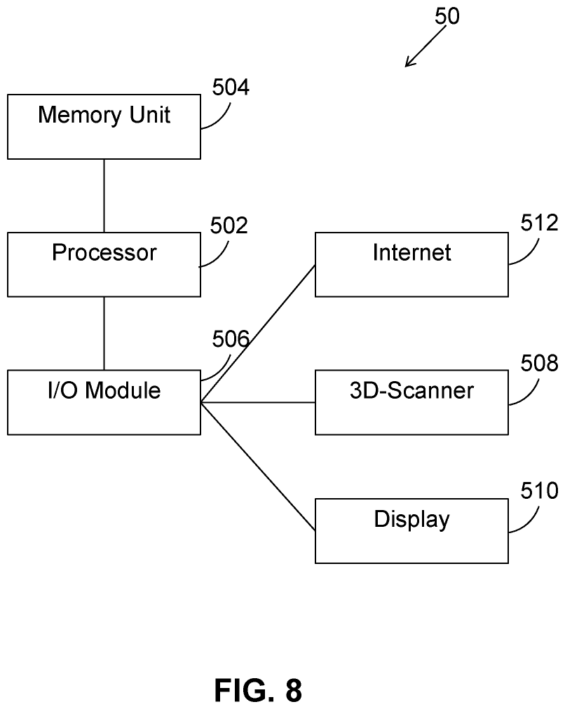

FIG. 8 schematically illustrates, according to an exemplary embodiment, a block diagram of a system for comparing a position and orientation of an at least one implanted dental implant 20 in a patient's mouth with a planned position and orientation of the at least one dental implant 20 in the patient's mouth. This system is also known as “comparison system 50”.

According to one embodiment, the comparison system 50 is configured to manually perform the comparison method 40 by a user. In other words, the user uses components of the comparing system 50 to manually perform the comparison method 40. According to another embodiment, the comparison system 50 is configured to automatically perform the comparison method 40. In other words, the comparison system 50 performs the comparison method 40 without participation of a user. According to yet another embodiment, the comparison system 50 is configured to partially manually and partially automatically perform the comparison method 40. In other words, the user uses components of the comparison system 50 to manually perform some steps of the comparison method, and the comparison system 50 automatically performs the other steps. An example of the yet another embodiment is that the user manually performs steps 402 and 404, shown in FIG. 7, while using components of the comparison system 50, and the comparison system 50 automatically performs step 406, 408 and 410, shown in FIG. 7.

According to one embodiment, the comparison system 50 is a computerized system. According to another embodiment, the comparison system 50 comprises a processor 502 configured to perform computations required during the performance of the comparison method 40. Any type of processor 502 known in the art is under the scope of the present subject matter, for example, but not limited to, a central processing unit (CPU), a microprocessor, an electronic circuit, an Integrated Circuit (IC), a digital signal processor (DSP), a microcontroller, a field programmable gate array (FPGA), an application specific integrated circuit (ASIC), and the like.

According to another embodiment, the comparison system further comprises a memory unit 504 connected to the processor 502 and configured to store data. Any type of memory unit 504 known in the art is under the scope of the present subject matter. For example, the memory unit 504 can be persistent or volatile. For example, but not limited to, the memory unit 504 can be a Flash disk, a random access memory (RAM), a memory chip, an optical storage device such as a CD, a DVD, or a laser disk; a magnetic storage device such as a tape, a hard disk, storage area network (SAN), a network attached storage (NAS), or others; a semiconductor storage device such as Flash device, memory stick, or the like. In some exemplary embodiments, the memory unit 504 can retain program code to activate the Processor 502 to perform acts associated with any of the steps of the comparison method 40. The memory unit 504 can also be used to retain 3D-images processed during the operation of the comparison method 40.

According to yet another embodiment, the comparison system 50 further comprises an input/output (I/O) module 506, connected to the processor 502 and configured to transmit, or receive, or transmit and receive, information and instructions between the processor 502 and other components of the comparison system 50, as described hereinafter. In some exemplary embodiment, the I/O module 506 is configured to receive data, for example from the internet and a 3D-scanner, and transmit data, for example to a display.

According to a further embodiment, the comparison system 50 further comprises a 3D-scanner 508 connected to the I/O module 506 and configured to acquire 3D-images, preferably intra-oral 3D-images. According to another preferred embodiment, the 3D-scanner 508 is configured to acquire visual light 3D-images. Any type of 3D-scanner 508 known in the art is under the scope of the present subject matter, for example, but not limited to, a dental 3D-scanner.

According to one embodiment, the comparison system 50 further comprises a display 510 connected to the I/O module 506 and configured to display data received from the processor 502 through the I/O module 506. Any type of display 510 known in the art is under the scope of the present subject matter, for example, but not limited, a monitor, a TV screen, a printer and the like. The display 510 is configured to show, for example, 3D-images that are processed during the performance of the comparison method 40.

According to one embodiment, the I/O module 506 is configured to be connected to the internet 512, as known in the art.

According to one embodiment, the library of images of various types of virtual multifunctional abutments 10 and the library of images of various types of virtual dental implants 20 can be stored in the memory unit 504. According to another embodiment, the the library of images of various types of virtual multifunctional abutments 10 and the library of images of various types of virtual dental implants 20 can be stored in the internet 512 that according to some embodiments can be connected to the I/O module 506. According to yet another embodiment, the library of images of various types of virtual multifunctional abutments 10 and the library of images of various types of virtual dental implants 20 can be stored partially in the memory unit 504 and partially in the internet 512.

It is appreciated that certain features of the subject matter, which are, for clarity, described in the context of separate embodiments, may also be provided in combination in a single embodiment. Conversely, various features of the subject matter, which are, for brevity, described in the context of a single embodiment, may also be provided separately or in any suitable sub combination.

Although the subject matter has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A multifunctional abutment configured to releasably connect to a dental implant, the multifunctional abutment comprising:
a body; and
a head at an upper edge of the body,
wherein the multifunctional abutment is configured to allow execution of multiple steps during an implantation procedure of the dental implant, while using same multifunctional abutment.

2. The multifunctional abutment of claim 1, further configured to connect to the dental implant with a connector.

3. The multifunctional abutment of claim 1, further comprising at a top side of the head a carrier connection element configured to be gripped by a carrier.

4. The multifunctional abutment of claim 1, wherein the body is configured to serve as an implant mount, so the dental implant could be inserted into a bone through a surgical guide.

5. The multifunctional abutment of claim 1, further comprising a stopper at a bottom edge of the head, or in a border between the head and the body, wherein the stopper is configured to prevent further insertion of the dental implant into a bone when the stopper comes in contact with a surgical guide.

6. The multifunctional abutment of claim 1, further configured to serve as an analog transfer, by being configured to be embedded in a hardened impression material and released from the dental implant.

7. The multifunctional abutment of claim 1, wherein the head is further configured to serve as a scan body, thereby the multifunctional abutment is further configured to serve as a digital transfer.

8. The multifunctional abutment of claim 7, wherein the head further comprises an orientation mark that is configured to allow determination of an orientation of the dental implant during digital impression.

9. The multifunctional abutment of claim 7, wherein the head further comprises a marking configured to mark a type of the dental implant in a scanned image acquired during scanning of the multifunctional abutment.

10. The multifunctional abutment of claim 7, wherein at least part of a surface of the head is configured to be scanned and seen in a scanned image that is acquired during scanning.

11. The multifunctional abutment of claim 10, wherein the at least part of the surface of the head that is configured to be scanned and seen in the scanned image is chemically treated so it could be used directly as a scan body.

12. The multifunctional abutment of claim 10, wherein the at least part of the surface of the head that is configured to be scanned and seen in the scanned image is opaque to light.

13. The multifunctional abutment of claim 1, wherein at least part of the multifunctional abutment is magnetic.

14. The multifunctional abutment of claim 13, wherein the multifunctional abutment is configured to be used as an implant stability quotient (ISQ) gauge.

15. The multifunctional abutment of claim 1, wherein the multifunctional abutment is made of a biocompatible material.

16. The multifunctional abutment of claim 1, wherein the multifunctional abutment is configured to be milled to form a customized abutment that is configured to be used as an abutment that holds a crown attached to the dental implant.

17. A method for comparing a position and orientation of an at least one implanted dental implant in a patient's mouth with a planned position and orientation of the at least one dental implant in the patient's mouth, the method comprising:
providing a first 3D-image of a patient's mouth before implantation, comprising a 3D-image showing a planned position and orientation of at least one dental implant implanted in the patient's mouth;
providing a second 3D-image of a patient's mouth after implantation of at least one dental implant, each dental implant is connected to a multifunctional abutment of claim 1;
transforming the second 3D-image to a third 3D-image, by adding to the second 3D-image at least one 3D-image of at least one virtual multifunctional abutment and at least one 3D-image of at least one virtual dental implant, wherein the at least one virtual multifunctional abutment is similar to the at least one multifunctional abutment that is in the patient's mouth, and wherein the at least one virtual dental implant is similar to the at least one dental implant that is in the patient's mouth, and wherein the third 3D-image shows a position and orientation of the at least one multifunctional abutment and the at least one dental implant that are in the patient's mouth;
overlapping the first 3D-image with the third 3d-image giving rise to a combination 3d-image; and
comparing the first 3D-image with the third 3D-image in the combination 3D-image for evaluating a difference in the position and orientation of the at least one implanted dental implant relative to the planned position and orientation of the at least one dental implant.

18. The method of claim 17, wherein the second image is acquired by scanning the patient's mouth.

19. A system for comparing a position and orientation of an at least one implanted dental implant in a patient's mouth with a planned position and orientation of the at least one dental implant in the patient's mouth according to claim 17, the system comprising:
a processor configured to perform computations required during the comparing;
a memory unit connected to the processor and configured to store data;
an input/output (I/O) module, connected to the processor and configured to transmit, or receive, or transmit and receive information and instructions between the processor and other components of the system; and
a 3D-scanner connected to the I/O module and configured to acquire 3D-images.

20. The system of claim 19, further comprising a display connected to the I/O module and configured to display data received from the processor through the I/O module.
